(19) United States
(12) Patent Application Publication
(10) Pub. No.: US 2018/0094582 A1
(43) Pub. Date: Apr. 5, 2018

(54) TURBOFAN ENGINE FOR A CIVIL SUPERSONIC AIRCRAFT

(71) Applicant: Rolls-Royce Deutschland Ltd & Co KG, Blankenfelde-Mahlow (DE)

(72) Inventors: Knut ROSENAU, Herzfelde (DE); James Robert MCLEAVY HILL, Berlin (DE); Marco ROSE, Freiberg (DE)

(21) Appl. No.: 15/721,050

(22) Filed: Sep. 29, 2017

(30) Foreign Application Priority Data
Oct. 4, 2016 (DE) 10 2016 118 779.8

(51) Int. Cl. F02C 7/045; F02K 3/06

(52) U.S. Cl. CPC F02C 7/045; F02C 3/04; F02K 3/06

(57) ABSTRACT

A turbofan engine for a civil supersonic aircraft, including: a multi-stage fan, wherein each stage of the multi-stage fan has a fan rotor with rotor blades and a fan stator with stator blades; an inlet flow channel that leads through the fan rotor of the first stage of the multi-stage fan; a primary flow channel that leads through a core engine of the turbofan engine; and a secondary flow channel that leads past the core engine. The inlet flow channel divides into the primary flow channel and the secondary flow channel. It is provided that the fan rotors of all stages of the fan are arranged in the inlet flow channel before it is divided into the primary flow channel and the secondary flow channel.

### REFERENCE TO RELATED APPLICATION

This application claims priority to German Patent Application No. 10 2016 118 779.8 filed on Oct. 4, 2016, the entirety of which is incorporated by reference herein.

### BACKGROUND

The invention relates to a turbofan engine for a civil supersonic aircraft.

After civil supersonic flight suffered a setback following the termination of the operation of the supersonic passenger plane “Concorde”, lately the interest in the development of supersonic aircrafts for the civil area, and correspondingly also the interest in efficient aircraft engines suitable for supersonic operation, has again been rising.

The engine RB199 that is realized in the Tornado fighter jet comprises a three-stage fan and an adjustable thrust nozzle with a thrust reverser. Adjustable converging-diverging thrust nozzles are known from the engine EJ200 of the Eurofighter fighter jet engine, for example. However, engines for a supersonic operation as they are known from military technology cannot be used in the civil area, since the requirements, for example with respect to engine noise and fuel consumption, are not sufficient.

It is known that the fan noise is reduced as the distance between the fan rotor and the fan stator increases; representatively, Balombin, J. R., et al.: “Effect of Rotor-to-Stator Spacing on Acoustic Performance of a full-scale fan (QF-5) for Turbofan Engine”, NASA Technical Memorandum X-3101, September 1974, is cited here.

Document DE 2 119 495 A describes a double-stage fan with a first fan rotor and a second fan rotor, in which the impeller blades of the second fan rotor extend across the secondary flow channel (bypass flow channel) and the primary flow channel of the engine. EP 1 564 397 B1 describes the arrangement of a second fan rotor only in the secondary flow channel.

There is a need to provide a turbofan engine that is suitable for supersonic operation, having a new design of the fan.

### SUMMARY

According to an embodiment of the invention, a turbofan engine with a multi-stage fan is provided, wherein each stage of the multi-stage fan has a fan rotor with rotor blades and a fan stator with stator blades. The engine forms an inlet flow channel that leads through the fan rotor of the first stage of the multi-stage fan. A primary flow channel leads through the core engine of the turbofan engine, which is comprised of a compressor, a combustion chamber, and a turbine. A secondary flow channel leads past the core engine. The inlet flow channel splits behind a flow divider or splitter into the primary flow channel and the secondary flow channel. During operation of the turbofan engine, the air mass flow that is sucked in by the engine is divided into a primary air mass flow that flows through the primary flow channel, and a secondary air mass flow that flows through the secondary flow channel.

It is provided that the fan rotors of all stages of the fan are arranged in the inlet flow channel before it divides into the primary flow channel and the secondary flow channel. Accordingly, the sucked-in air mass flow is split into a secondary air mass flow and a primary air mass flow only behind the rotor stage of the last fan stage.

An embodiment of the present invention thus provides a turbofan engine with a compact multi-stage fan, with all its fan rotors being arranged in the inlet flow channel before it is divided into the primary flow channel and the secondary flow channel. In this manner, it is facilitated that all fan rotors can be connected to the drive shaft in a simple manner. Here, it can for example be provided that the individual fan rotors are embodied in BLISK design and that they are connected to each other and to the drive shaft in a torque-proof manner.

Terms such as “in front”, “behind”, “frontal” and “rear” always refer to the air flow direction. Thus, a first structural component that is arranged in front of a second structural component is arranged upstream of the second structural component. In that case, the second structural component is arranged downstream of the first structural component.

The turbofan engine is for example designed for a flight velocity range of Ma 1.0 to Ma 3.0, in particular of Ma 1.2 to Ma 1.8, and during take-off of the aircraft for a thrust range of 44.482 N (10.000 lbf) to 444.820 N (100.000 lbf), in particular for a thrust range of 66.723 N (15.000 lbf) to 133.446 N (30.000 lbf).

According to one embodiment of the invention, it applies to at least one fan rotor or fan stator that, in the radial flow center of the inlet flow channel, the axial distance between the blades of a fan rotor or fan stator and the blades of the fan stator or fan rotor that is arranged directly upstream in the flow direction is between 60% and 150%, in particular between 80% and 130%, of the axial length of the blades of the fan stator or fan rotor that is arranged upstream. If the multi-stage fan is a double-stager fan, it means that the axial distance between the blades of the fan stator of the first stage to the blades of the fan rotor of the first stage is between 60% and 150%, in particular between 80% and 130%, of the axial length of the blades of the first fan rotor, and/or that the axial distance between the blades of the fan rotor of the second stage to the blades of the fan stator of the first stage is between 60% and 150%, in particular between 80% and 130%, of the axial length of the blades of the fan stator of the first stage. The same distance ratio also applies to a three-stage fan.

The quoted distances likewise apply in the radial flow center of the inlet flow channel. It is formed by the geometrical center of the inlet flow channel, which is configured as an annular channel, and that is delimited by a fan hub and the outer flow path boundary. By regarding the radial flow center, the blades and their distance are regarded in a defined radial height.

Thus, aspects of the invention realize a large axial distance between the fan rotor blades and the fan stator blades. In this manner, the generation of fan noise is reduced. Thus, the invention provides an elongate design of the multi-stage fan, in which the axial distances between the fan rotor and the fan stator are chosen so as to be large, although all fan rotors are arranged in the inlet flow channel.

In order to achieve a better flow from the first fan stage to the second fan stage, in a further embodiment of the invention, the blade tip at the inlet edge (i.e. the axially frontal edge) of the second rotor stage of the fan is located radially further inside with respect to the machine axis by between 2% to 10%, in particular by between 3% to 6%, than the blade tip at the inlet edge of the first rotor stage of the fan.

In a further embodiment of the invention it is provided that it applies to at least one of the stages of the fan that the number of the blades of the fan stator of this stage is two times to five times, in particular three times, the number of the blades of the fan rotor of this stage plus or minus a number m that may be between 1 to 10, in particular may be between 3 and 6, so that the number of the blades of the fan rotor and the number of the blades of the fan stator do not have a whole-number ratio with respect to each other. For a double-stage fan, this means that the number of the blades of the fan stator of the first stage is approximately twice to five times, in particular approximately three times, the number of the blades of the fan rotor of the first stage. Here, it is ensured that no integral multiple of the number of the rotor and stator blades is realized. The deviation of the number of the fan stator blades from the multiple of the preceding fan rotor blades can be between 1 to 10, in particular between 3 and 6. Due to the different number of rotor blades and stator blades of a stage, interferences between the rotors and the stators are avoided.

According to a further embodiment of the invention, it is provided that it applies to at least one fan stage that the number of the rotor blades of the rear fan stage is increased by 10% to 40%, in particular by 15% to 25%, in particular by 20%, with respect to the number of the rotor blades of the front fan stage. For a double-stage, this means that the number of the rotor blades of the second fan stage is increased by 10% to 40%, in particular by 15% to 25%, in particular by 20%, with respect to the number of the rotor blades of the first fan stage. A third fan stage would have the same number ratio with respect to its preceding stage. Through the different number of rotor blades in the individual fan stages, acoustic interferences between the fan rotors are avoided or reduced. This is another measure for noise reduction.

It can be provided that, for the purpose of further noise reduction, the number of the stator blades of a fan stage differs from the number of the rotor blades of this stage and from the number of the stator blades and the rotor blades of each of the preceding stages. In this way, acoustic interferences are reduced or avoided.

As has already been mentioned, the fan rotor according to an embodiment can be formed by n rotors in BLISK design that are connected to one another in a torque-proof manner, wherein n indicates the number of the stages of the multi-stage fan. Here, the fan rotors of the individual stages that are embodied in BLISK design can for example be bolted or welded together.

In a further embodiment of the invention, it is provided that a reduction gear is provided in the drive train between a low-pressure turbine of the engine and the fan in order to reduce the rotational speed from a high-speed low-pressure turbine to the multi-stage fan. The reduction gear is embodied as a planetary gear, for example.

The stator blades of the fan stator of the individual stages can in principle be arranged in a fixedly attached manner, or alternatively in a rotatable manner. Accordingly, it is provided in an embodiment of the invention that it applies to at least one fan stage that the blades of the fan stator are rotatable about a radial axis. This can for example be achieved by means of adjusting rings and adjusting levers and by a rotatable mounting of the stator blades.

According to aspects of the present invention, the fan rotors of all stages of the fan are arranged in the inlet flow channel before it splits into the primary flow channel and the secondary flow channel. Accordingly, except for the last stage, all fan stators of the individual fan stages are also arranged in the inlet flow channel. In contrast to that, according to one embodiment, the fan stator of the last fan stage is arranged at the entry of the secondary flow channel and at the entry of the primary flow channel in a split manner, respectively forming guide baffles there.

The turbofan engine comprises an engine intake that is suitable for supersonic operation, and is provided and serves for slowing down the inflowing air to velocities below Ma 1.0. According to an embodiment, it is provided that the engine intake is provided with a sound-absorbing cladding (also referred to as a “noise liner”) for additional noise reduction.

The invention also relates to a civil supersonic aircraft comprising a turbofan engine according to the invention.

### BRIEF DESCRIPTION OF THE DRAWINGS

The invention will be explained in more detail on the basis of exemplary embodiments with reference to the accompanying drawings in which:

FIG. 1 shows an exemplary embodiment of a turbofan engine with a double-stage fan, in which the fan rotors of both stages are arranged in the inlet flow channel before it is divided into a primary flow channel and a secondary flow channel;

FIG. 2 shows an exemplary embodiment of a turbofan engine with a double-stage fan corresponding to the embodiment of FIG. 1, wherein the blades of the fan stator of each stage are embodied in a rotatable manner; and

FIG. 3 shows an exemplary embodiment of a turbofan engine with a double-stage fan corresponding to the embodiment of FIG. 1, wherein the turbofan engine additionally has a planetary gear for reducing the fan's rotational speed.

### DETAILED DESCRIPTION

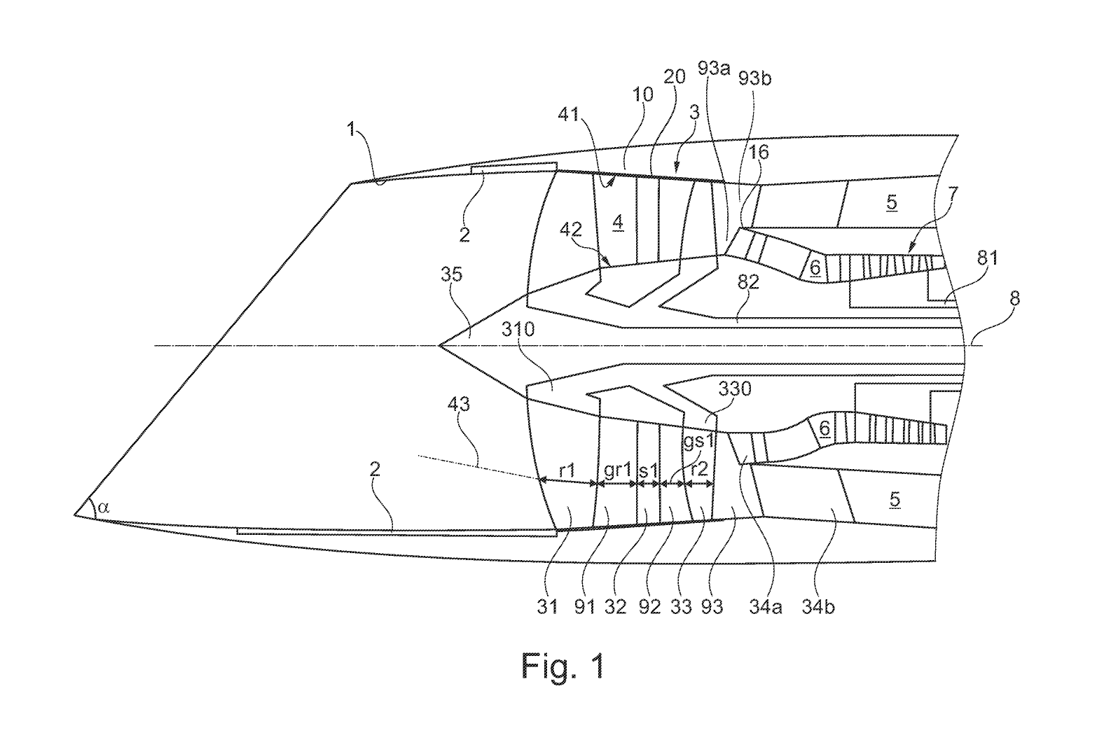

FIG. 1 shows an upstream part of a turbofan engine for a civil supersonic aircraft. The turbofan engine comprises an engine intake 1, a multi-stage fan 3, a primary flow channel 6 that leads through a core engine, and a secondary flow channel 5 that leads past the core engine. The secondary flow channel 5 is also referred to as the bypass flow channel or bypass channel. The turbofan engine comprises a machine axis or engine central line 8. The machine axis 8 defines an axial direction of the turbofan engine. A radial direction of the turbofan engine extends perpendicular to the axial direction.

The core engine is shown only partially and comprises in a per se known manner a compressor, a combustion chamber, and a turbine. In the shown exemplary embodiment, the compressor comprises a high-pressure compressor 7. A low-pressure compressor is formed by the areas of the fan rotor 3 that are located close to the hub. The turbine (not shown) that is arranged behind the combustion chamber (not shown) comprises a high-pressure turbine and a low-pressure turbine. The high-pressure turbine drives a high-pressure shaft 81 that connects the high-pressure turbine to the high-pressure compressor 7. The low-pressure turbine drives a low-pressure shaft 82 that connects the low-pressure turbine to the multi-stage fan 3. As further components that are not shown in FIG. 1, the turbofan engine comprises a mixer that mixes the air of the secondary flow channel 5 and of the primary flow channel 6 behind the core engine, as well as a thrust nozzle. The engine can additionally have a thrust reverser.

The turbofan engine is arranged inside an engine nacelle 10. It may be connected to the aircraft fuselage via a pylon, for example.

The engine intake 1 forms a supersonic air inlet and is accordingly provided and suited for the purpose of slowing down inflowing air to velocities below Ma 1.0 (Ma=Mach number). In FIG. 1—but not necessarily—the engine intake is beveled, forming an angle α, wherein the lower edge projects with respect to the upper edge. This serves for achieving an advantageous compression shock configuration during supersonic flight. However, in principle the engine intake can be formed in a straight manner, i.e. with an angle α of 90°, or a different angle than the one shown.

The engine intake 1 has an interior cladding with a sound-absorbing material 2. This serves for reducing engine noise.

The fan 3 is formed as a multi-stage fan, in the shown exemplary embodiment as a double-stage fan. Accordingly, the multi-stage fan 3 comprises a first fan rotor 31 and a first fan stator 32, which form a front fan stage, as well as a second fan rotor 33 and a second fan stator 34a, 34b, which form a rear fan stage. Upstream, the fan 3 is provided with a nose cone 35. The fan rotors 31, 33 respectively comprise a plurality of rotor blades that are connected to a fan disc 310, 330 of the fan 3. The fan stator 32 of the front fan stage comprises a plurality of stator blades that are mounted in a fan housing 20, which is shown in a schematic manner. The fan stator of the rear fan stage is split and is formed by a guide baffle 34a that is formed at the entry of the primary flow channel 6, and by a guide baffle 34b that is formed at the entry of the secondary flow channel 5.

An inlet flow channel 4 extends through the fan 3 and is divided behind the fan rotor 33 of the rear stage starting from a splitter 16 into the primary flow channel 6 and the secondary flow channel 5. The inlet flow channel 4 is formed by an annular space that extends downstream of the nose cone 35 between a radially outer flow path boundary 41 and a radially inner flow path boundary 42. The radially outer flow path boundary 41 is formed by the fan housing 20 or by wall areas adjoining thereto. The radially inner flow path boundary 42 is formed by the annulus of the fan discs 310, 330 or by hub-side boundary surfaces adjoining thereto.

The annular space of the inlet flow channel 4 has a flow center 43 that forms the geometrical center of the inlet flow channel 4 between the outer flow path boundary 41 and the inner flow path boundary 42.

The two fan rotors 31, 33 are driven via the low-pressure shaft 82 that is coupled to the fan discs 310, 330.

A first gap 91 is located between the blades of the fan rotor 31 and the blades of the fan stator 32. A second gap 92 is located between the blades of the fan stator 32 and the blades of the fan rotor 33. A third gap 93, which is divided into a radially inner gap 93a on the one hand and a radially outer gap 93b on the other, is located between the blades of the fan rotor 33 and the blades of the split fan stator 34a, 34b. In the flow center 43 of the inlet flow channel 4, the blades of the fan rotor 31 of the front stage have an axial length r1, the first gap 91 has an axial length gr1, the blades of the fan stator 32 of the front stage have an axial length s1, the second gap 92 has an axial length gs1, and the blades of the fan rotor 33 of the rear stage have an axial length r2.

For realizing a low engine noise, large distances gr1 and gs1 are provided, wherein the following relationships apply: The axial distance gr1 between the blades of the fan stator 32 of the first stage and the blades of the fan rotor 31 of the first stage is between 60% and 150%, in particular between 80% and 130%, of the axial length r1 of the blades of the fan rotor 31. Further, the axial distance gs1 between the blades of the fan rotor 33 of the second stage and the blades of the fan stator 32 of the first stage is between 60% and 150%, in particular between 80% and 130%, of the axial length 51 of the blades of the fan stator 32.

Further, the following relationships are realized for the purpose of noise reduction. The number of the blades of the fan stator 32 of the first stage is approximately twice to five times, in particular approximately three times, the number of the blades of the fan rotor 31 of the first stage, and namely is embodied so that integral multiples are avoided between the numbers of blades. Here, the deviation of the number of the fan stator blades from the multiple of the preceding fan rotor blades can be between 1 to 10, in particular between 3 and 6. Further, the number of the blades of the fan rotor 33 of the second fan stage is increased by at least 10% to 40%, in particular by 15% to 25%, in particular by 20%, with respect to the number of the blades of the fan rotor 31 of the first fan stage.

Further, it can be provided for the purpose of noise reduction that the guide baffle 34a at the entry of the primary flow channel 6 and the guide baffle 34b at the entry of the secondary flow channel 5 respectively have a different number of blades as compared to the number of the stator blades and rotor blades of the fan rotors and fan stators that are arranged upstream.

It is to be understood that in the engine of FIG. 1, both fan rotors 31, 33 are arranged in the inlet flow channel 4 before it is separated into the primary flow channel 6 and the secondary flow channel 5. This facilitates a compact structure of the multi-stage fan 3 and of the entire engine. In order to achieve a particularly compact structure, it can be provided according to one embodiment variant that the two fan rotors 31, 33 are respectively embodied in BLISK design, wherein the two rotors 31, 33 are connected to each other in a torque-proof manner, for example by being bolted or welded together.

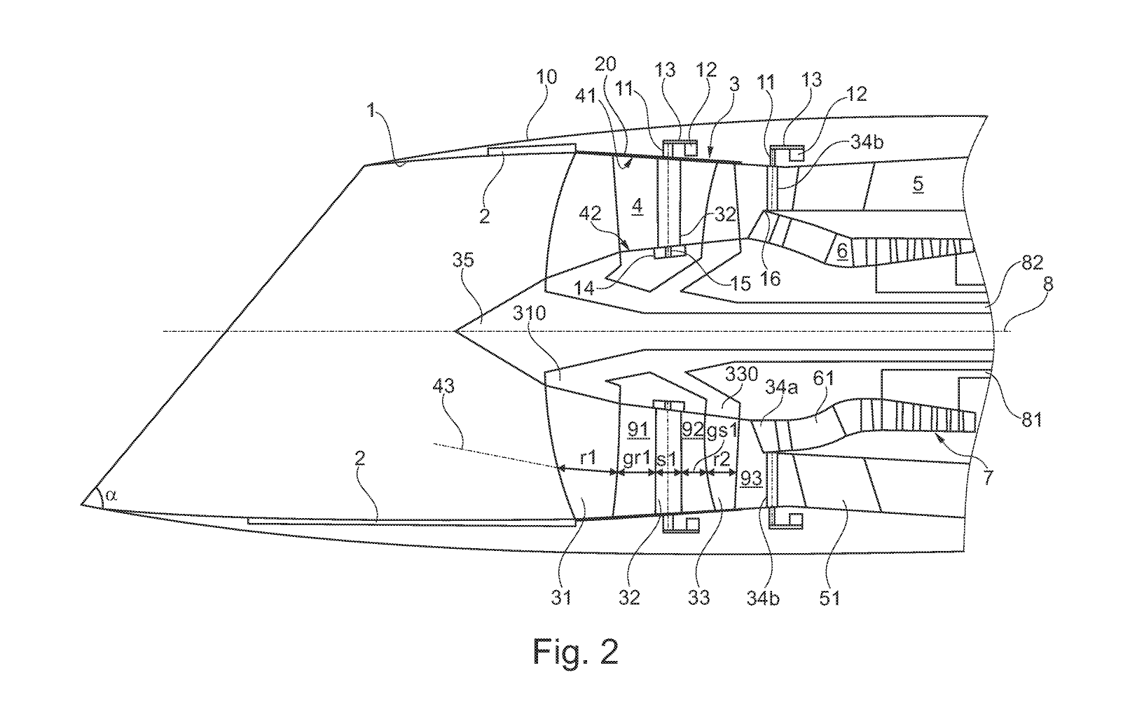

FIG. 2 shows an exemplary embodiment that differs from the exemplary embodiment of FIG. 1 in the fact that the blades of the fan stator 32 of the front stage and the blades of the fan stator 34b of the rear stage are embodied so as to be respectively rotatable about their radial longitudinal axis. For this reason, it is provided that the stator blades are respectively mounted in a rotatable manner, for which purpose the blades of the fan stator 32 have rotatable mountings 11 in the fan housing 20 and mountings 15 in a retaining ring 14. An adjustment is realized via an adjusting ring 12 that extends around the circumferential direction and that is connected to the blades via the adjusting lever 13. In a corresponding manner, the fan blades of the fan stator 34a have rotatable mountings 11 with an associated adjusting ring 12 and adjusting lever 13.

Through the rotation of the stator blades 32, 34b, an efficiency increase can be realized by adjusting the blade position to the operating conditions. Also, the surge line of the compressor 7 can be varied by means of a suitable blade position.

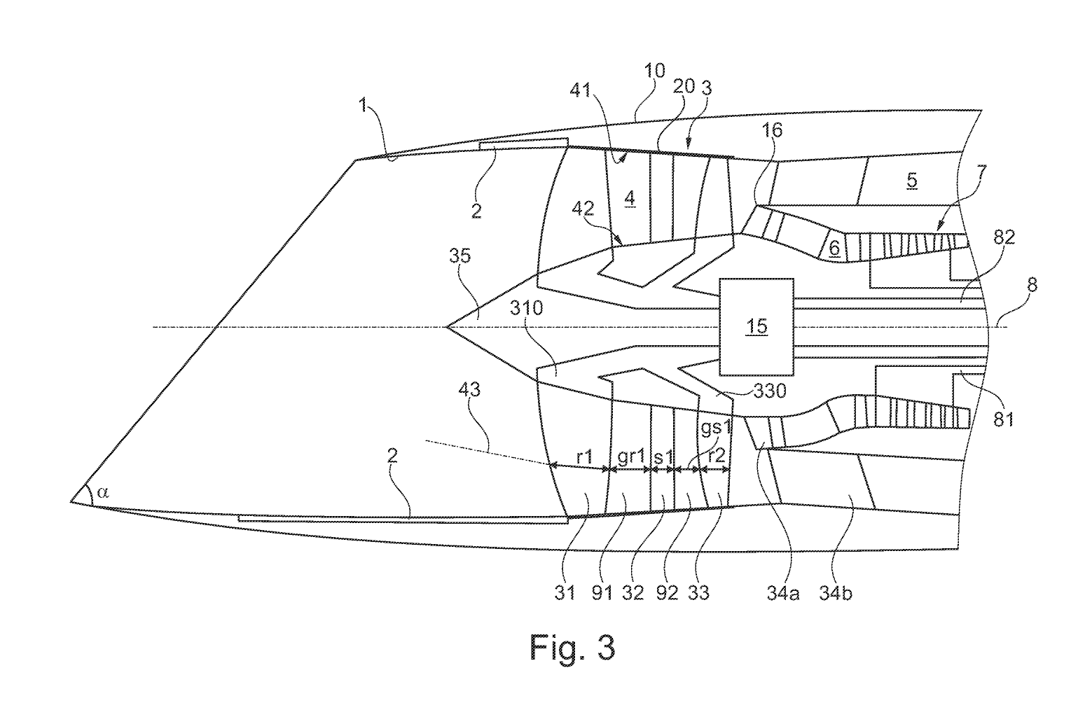

FIG. 3 shows an exemplary embodiment that differs from the exemplary embodiment of FIG. 1 in that the low-pressure turbine or the low-pressure shaft 82 is coupled to the multi-stage fan 3 via a reduction gear 15. The reduction gear can for example be embodied as a planetary gear, and leads to a reduction of the fan's rotational speed by the rotational speed of the high-speed low-pressure turbine or the low-pressure shaft 82 being reduced to the multi-stage fan 3.

The present invention is not limited in its design to the above-described exemplary embodiments, which are to be understood merely as examples. For example, the multi-stage fan can be embodied as a three-stage fan instead of as a double-stage fan. For this case it is also provided that all fan rotors of the multi-stage fan 3 are arranged in the inlet flow channel 4 before it is divided into the primary flow channel 6 and the secondary flow channel 5, wherein the axial distances of the fan stator blades or the fan rotor blades can be between 60% to 150%, in particular between 80% and 130%, of the axial length of the preceding fan rotor or fan stator blades.

It is furthermore pointed out that the features of the individually described exemplary embodiments of the invention can be combined in various combinations with one another. Where areas are defined, they include all the values within these areas and all the sub-areas falling within an area.

What is claimed is:

1. Turbofan engine for a civil supersonic aircraft, comprising:
a multi-stage fan, wherein each stage of the multi-stage fan comprises a fan rotor with rotor blades and a fan stator with stator blades,
an inlet flow channel that leads through the fan rotor of the first stage of the multi-stage fan,
a primary flow channel that leads through the core engine of the turbofan engine,
a secondary flow channel that leads past the core engine,
wherein the inlet flow channel divides into the primary flow channel and the secondary flow channel, and
wherein the fan rotors of all stages of the fan are arranged in the inlet flow channel before it is divided into the primary flow channel and the secondary flow channel.

2. Turbofan engine according to claim 1, wherein it applies to at least one fan rotor or fan stator that, in the radial flow center of the inlet flow channel, the axial distance between the blades of a fan rotor or fan stator and the blades of the fan stator or fan rotor that is arranged directly upstream in the flow direction is between 60% and 150%, in particular between 80% and 130%, of the axial length of the blades of the fan stator or fan rotor that is arranged upstream.

3. Turbofan engine according to claim 1, wherein it applies to at least one of the stages of the fan that the number of the blades of the fan stator of this stage is two times to five times, in particular three times, the number of the blades of the fan rotor of this stage plus or minus a number m, so that the number of the blades of the fan rotor and the number of the blades of the fan stator do not have a whole-number ratio with respect to each other.

4. Turbofan engine according to claim 3, wherein the number m lies between 1 to 10, in particular between 3 and 6.

5. Turbofan engine according to claim 1, wherein it applies to at least two fan stages that the number of the blades of the fan rotor of the rear fan stage is increased by 10% to 40%, in particular by 15% to 25%, in particular by 20%, with respect to the number of the blades of the fan rotor of the front fan stage.

6. Turbofan engine according to claim 1, wherein the number of the blades of the fan stator of a fan stage differs from the number of the blades of the fan rotor of this stage and from the number of the stator blades and the rotor blades of each preceding stage.

7. Turbofan engine according to claim 1, wherein the fan is a double-stage fan with a first front stage and a second rear stage, wherein the first stage has a first fan rotor and a first fan stator, and the second fan stage has a second fan rotor and a second fan stator, and wherein the first fan rotor and the second fan rotor are arranged in the inlet flow channel before it is divided into the primary flow channel and the secondary flow channel.

8. Turbofan engine according to claim 7, wherein, in the radial flow center of the inlet flow channel, the axial distance between the blades of the fan stator of the first stage and the blades of the fan rotor of the first stage is between 60% and 150%, in particular between 80% and 130%, of the axial length of the blades of the fan rotor.

9. Turbofan engine according to claim 7, wherein, in the radial flow center of the inlet flow channel, the axial distance between the blades of the fan rotor of the second stage and the blades of the fan stator of the first stage is between 60% and 150%, in particular between 80% and 130%, of the axial length of the blades of the fan stator.

10. Turbofan engine according to claim 7, wherein the number of the blades of the fan stator of the first stage is two times to five times, in particular three times, the number of the blades of the fan rotor of the first stage plus or minus a number m, so that the number of the blades of the fan rotor and the number of the blades of the fan stator do not have a whole-number ratio with respect to each other.

11. Turbofan engine according to claim 7, wherein the number of the blades of the fan rotor of the second fan stage is increased by at least 10% to 40%, in particular by 15% to 25%, in particular by 20%, with respect to the number of the blades of the fan rotor of the first fan stage.

12. Turbofan engine according to claim 1, wherein the blade tip at the inlet edge of the second rotor stage of the fan is radially further inside with respect to the machine axis by between 2% to 10%, in particular by between 3% to 6%, than the blade tip at the inlet edge of the first rotor stage of the fan.

13. Turbofan engine according to claim 1, wherein the fan rotor is formed by n rotors in BLISK design that are connected to each other in a torque-proof manner, wherein n is the number of the stages of the multi-stage fan.

14. Turbofan engine according to claim 1, wherein a reduction gear for reducing the fan's rotational speed is configured in the drive train between a low-pressure turbine of the engine and the fan.

15. Turbofan engine according to claim 1, wherein it applies to at least one fan stage that the blades of the fan stator are rotatable about their radial axis.

16. Turbofan engine according to claim 7, wherein the second fan stator is formed by stator blades at the beginning of the secondary flow channel and stator blades at the beginning of the primary flow channel.

17. Turbofan engine according to claim 1, wherein an engine intake, which is formed in front of the multi-stage fan, is provided with a sound-absorbing cladding.

18. Turbofan engine according to claim 1, wherein the engine is designed for a flight velocity range of Ma 1.0 to Ma 3.0, in particular of Ma 1.2 to Ma 1.8, and during the take-off of the aircraft is designed for a thrust range of 44.482 N to 444.820 N, in particular for a thrust range of 66.723 N to 133.446 N.

19. Turbofan engine for a civil supersonic aircraft, comprising:
a double-stage fan with a first front stage and a second rear stage, wherein each stage comprises a fan rotor with rotor blades and a fan stator with stator blades,
an inlet flow channel that leads through the fan rotor of the first stage of the multi-stage fan,
a primary flow channel that leads through a core engine of the turbofan engine,
a secondary flow channel that leads past the core engine, wherein
the inlet flow channel divides into the primary flow channel and the secondary flow channel,
the fan rotors of both stages of the fan are arranged in the inlet flow channel before it is divided into the primary flow channel and the secondary flow channel,
in the radial flow center of the inlet flow channel, the axial distance between the blades of the fan stator of the first stage and the blades of the fan rotor of the first stage is between 60% and 150%, in particular between 80% and 130%, of the axial length of the blades of the fan rotor of the first stage,
in the radial flow center of the inlet flow channel, the axial distance between the blades of the fan rotor of the second stage and the blades of the fan stator of the first stage is between 60% and 150%, in particular between 80% and 130%, of the axial length of the blades of the fan stator of the first stage,
it applies to each fan rotor and each fan stator of each stage that the number of its blades differs from the number of the blades of all other fan rotors and fan stators, and
the number of the blades of the fan rotor of the second stage is higher than the number of the blades of the fan rotor of the first stage.

20. Civil supersonic aircraft with a turbofan engine according to claim 1.
